(19) United States
(12) Patent Application Publication
(10) Pub. No.: US 2026/0056051 A1
(43) Pub. Date: Feb. 26, 2026

(54) SUNLIGHT HABIT EYEGLASSES

(71) Applicant: Microchip Technology Incorporated, Chandler, AZ (US)

(72) Inventor: Dragos Mihai, Bucharest (RO)

(73) Assignee: Microchip Technology Incorporated, Chandler, AZ (US)

(21) Appl. No.: 18/925,304

(22) Filed: Oct. 24, 2024

Related U.S. Application Data
(60) Provisional application No. 63/685,180, filed on Aug. 20, 2024.

(51) Int. Cl. G01J 1/42; G02C 7/02; G02C 11/00

(52) U.S. Cl. CPC G01J 1/4204; G01J 1/429; G02C 7/02; G02C 11/10

(57) ABSTRACT

Systems and methods to measure light being observed by a person's eyes, determine that the light has met a preset light threshold, and indicate this to the person. A device comprises: a sensor of a light; a controller to receive a sensor signal from the sensor and to determine the light has met a preset threshold, wherein the sensor signal corresponds to a light characteristic sensed by the sensor; and an indicator to receive an indicator signal from the controller and to generate an indicator to a user, wherein the indicator signal indicates a preset threshold has been met.

### PRIORITY STATEMENT

This application claims priority to U.S. Provisional Ser. No. 63/685,180 , filed Aug. 20, 2024, the contents of which are hereby incorporated in their entirety.

### TECHNICAL FIELD

The present disclosure relates to light exposure and in particular, light exposure an individual sees during a time period.

### BACKGROUND

Sunlight has effect over our overall health. Some experts considering it one of the pillars of health. Exposure to sunlight helps to set the circadian rhythm and improve overall mood. Sunlight provides a natural way for vitamin D intake. Studies show that two hours a day of exposure to sunlight can have big benefits for myopia in children. Statistics show that over 58% of people spend one hour or less outside to get natural sunlight. Conversely, there are downsides to exposure to blue light during the night. Blue light exposure may disrupt the body's circadian rhythm and disrupt sleep. There is currently no way to reliably measure how much sunlight individuals get during a day, what type of light, when in the day, and how much blue light an individual sees at night.

There is a need to measure how much sunlight individuals get during a day, what type of light, when in the day, and how much blue light an individual sees at night.

### SUMMARY OF THE INVENTION

According to an aspect, there is provided a method comprising: measuring a light characteristic of light proximate a person's eyes; determining that a measured light characteristic has met a light characteristic threshold, and indicating the light characteristic threshold has been met.

An aspect of a method of the preceding paragraph comprises setting the light characteristic threshold.

An aspect of a method of one of the preceding two paragraphs comprises configuring a light sensor so as to be positionable proximate the person's eyes.

An aspect of a method of one of the preceding three paragraphs, wherein the light characteristic is light type, light duration, or light intensity.

An aspect of a method of one of the preceding four paragraphs, wherein the light type is blue light, yellow light, or ultraviolet light.

An aspect of a method of one of the preceding five paragraphs, wherein indicating a light characteristic threshold has been met is sounding an audio speaker, displaying a visual light, vibrating a vibrator, sounding an alarm, displaying a visual display, storing a status flag in a memory register, or displaying a display on a computer.

An aspect of a method of one of the preceding six paragraphs, comprising changing light being viewed by the person's eyes in response to the light characteristic threshold having been met.

According to an aspect, there is provided a device comprising: a sensor to sense a light characteristic of light proximate to a person's eyes and to transmit a sensor signal, wherein the sensor signal corresponds to the light characteristic sensed by the sensor; a controller to receive the sensor signal from the sensor, to determine that the light characteristic has met a light characteristic threshold, and to generate an indicator signal, wherein the indicator signal indicates the light characteristic threshold has been met; and an indicator to receive the indicator signal from the controller and to generate an indication to a user.

An aspect of the device of the preceding paragraph provides, wherein the controller is to set the light characteristic threshold.

An aspect of the device of one of the preceding two paragraphs comprises a housing to be positioned proximate the person's eyes.

An aspect of the device of one of the preceding three paragraphs provides, wherein the light characteristic is light type, light duration, or light intensity.

An aspect of the device of one of the preceding four paragraphs provides, wherein the light type is blue light, yellow light, or ultraviolet light.

An aspect of the device of one of the preceding five paragraphs provides, wherein the indicator is an audio speaker, a visual light, a vibrator, an alarm, a visual display, a status flag stored in a memory register, or a display on a computer.

According to an aspect, there is provided a system comprising: a device comprising: a sensor to sense a light characteristic of light proximate to a person's eyes and to generate a sensor signal, wherein the sensor signal corresponds to the light characteristic sensed by the sensor; and a radio transmitter to transmit the sensor signal; a personal computing device comprising: a radio receiver to receive the sensor signal; a processor to receive the sensor signal from the radio receiver; and a memory comprising an application with instructions stored in the memory, which when the application is executed by the processor causes the processor to: determine that the light characteristic has met a light characteristic threshold, and generate an indicator signal, wherein the indicator signal indicates the light characteristic threshold has been met; and an indicator to receive the indicator signal from the processor and to generate an indication to the person.

An aspect of the system of the preceding paragraph provides, wherein the application comprises instructions stored in the memory, which when the application is executed by the processor causes the processor to set the light characteristic threshold.

An aspect of the system of one of the preceding two paragraphs provides, wherein the device comprises a housing to be positioned proximate the person's eyes.

An aspect of the system of one of the preceding three paragraphs provides, wherein the light characteristic is light type, light duration, or light intensity.

An aspect of the system of one of the preceding four paragraphs provides, wherein the light type is blue light, yellow light, or ultraviolet light.

An aspect of the system of one of the preceding five paragraphs provides, wherein the indicator is an audio speaker, a visual light, a vibrator, an alarm, a visual display, a status flag stored in a memory register, or a display on a computer.

An aspect of the system of one of the preceding six paragraphs provides, wherein the device comprises a lens and the application comprises instructions stored in the memory, which when the application is executed by the processor causes the lens to change light being viewed by the person's eyes in response to the light characteristic threshold having been met.

### BRIEF DESCRIPTION OF THE DRAWINGS

The figures illustrate examples of methods and devices to measure how much sunlight individuals get during a day, what type of light, when in the day, and how much blue light an individual sees at night.

FIG. 1A shows a perspective view of a pair of eyeglasses having frames and lenses.

FIG. 1B shows a side view of the left temple piece of the eyeglasses shown in FIG. 1A.

FIG. 1C shows a side view of the right temple piece of the eyeglasses shown in FIG. 1A.

FIG. 2A shows a perspective view of a pair of eyeglasses having frames and lenses.

FIG. 2B shows a side view of the left temple piece of the eyeglasses shown in FIG. 2A.

FIG. 2C shows a side view of the right temple piece of the eyeglasses shown in FIG. 2A.

FIG. 2D shows a perspective view of the eyeglasses shown in FIG. 2A, wherein the temple pieces are folded against the frames.

FIG. 3 shows a block diagram of a light monitoring and indicating system.

FIG. 4 shows a block diagram of a light processing system, that communicates with a computer over a network.

FIG. 5 shows a block diagram of a light processing device communicating via a radio communication link with a handheld mobile computer.

FIG. 6 shows a flow chart of a method for measuring a light characteristic of light proximate a person's eyes.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect, there is provided a pair of glasses that have light sensors and can register how much and which type of light a person has seen during the day. The glasses may also auto dim (or just vibrate to alert) if the light to which that person is exposed is too strong or if a particular dose has been fulfilled.

Eyeglasses may be equipped with light sensors. The light sensors may be positioned at the front of the rims to be close to the eyes to capture the same light as being absorbed by the eyes. If a person looks directly at a bright source of light or at an angle, the amount of light that actually hits the eye is different. The sensors may also detect information regarding what type of light it is (Blue, Yellow, UV) and the intensity. The lenses of the eyeglasses may be made from a specific type of material which is electrochromic, meaning under the influence of a current it will dim. This can happen automatically in two cases: either the light received is too powerful, like mid-day sun during a time of year when the intensity of the sun is at its peak; or a threshold amount of sunlight has been reached. Also, this function may be turned off by the user with the switch of a button. Two proximity sensors may be positioned at the temple part in the front of a pair of eyeglasses. A proximity sensor may indicate when the eyeglasses are being worn and when they are not being worn, which may enable the system to enter into a low power mode or power down completely. The eyeglasses may also have a vibration motor, which can be used to inform the wearer if the glasses will dim the light because it is too powerful, or the wearer has had enough light for the day. It can also be used to vibrate 2-3 times if the UV index is too high, and the wearer has been exposed for more than 30 minutes to it. The system may have a power supply, such as a battery, which may be placed at the mid-end temples of the frames, for comfort. The power source may provide power to the system sufficient to last for one day or more. A charging case may be the same as the glasses case. At the temples tips, where they fold and stick out under the glasses, charging pins may protrude for engagement with a charging pad, the same principle used in wireless headphones.

Aspects provide a system to provide an estimated Vitamin D intake based on the sunlight exposure. Aspects of the eyeglasses may display short messages on the inside of the lens to let the user know what is happening: sunlight requirement achieved/the sunlight is too bright/the glasses will dim/you are exposed to powerful UV light.

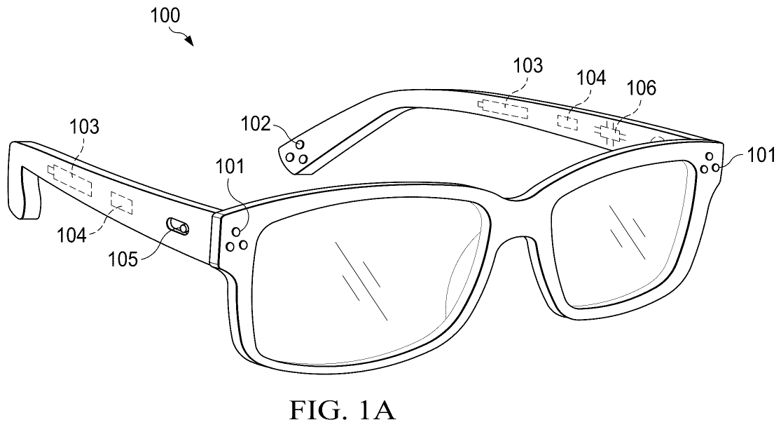

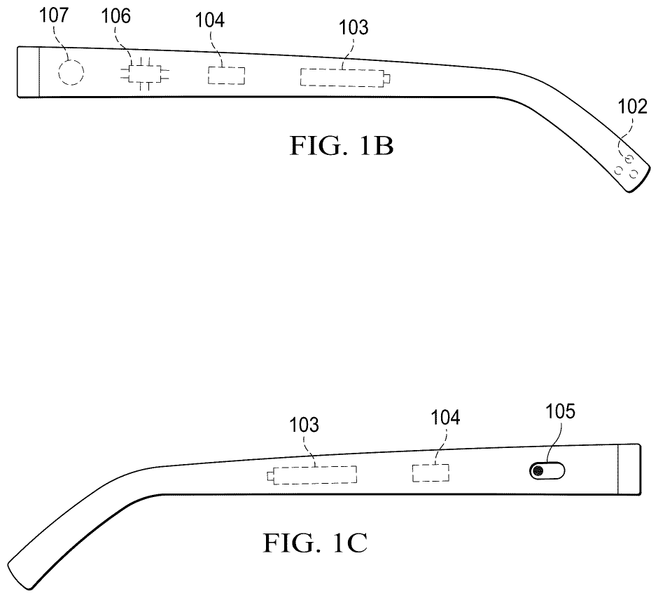

FIG. 1A shows a perspective view of a pair of eyeglasses 100 having frames and lenses. FIG. 1B shows a side view of the left temple piece of the eyeglasses 100 shown in FIG. 1A. FIG. 1C shows a side view of the right temple piece of the eyeglasses 100 shown in FIG. 1A. A light sensor 101 is positioned in the frame near a lens. Charging pins 102 are positioned at the distal end of the left temple piece. A battery 103 is positioned in the left temple piece and a battery 103 is positioned in the right temple piece. A haptic motor 104 is positioned in the left temple piece. An ON/OFF switch 105 is positioned in the right temple piece. A microprocessor 106 is positioned in the left temple piece. A proximity sensor 107 is positioned in the left temple piece.

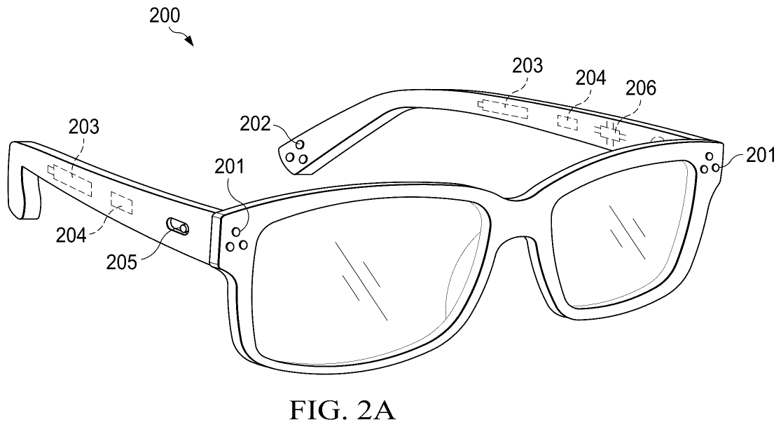

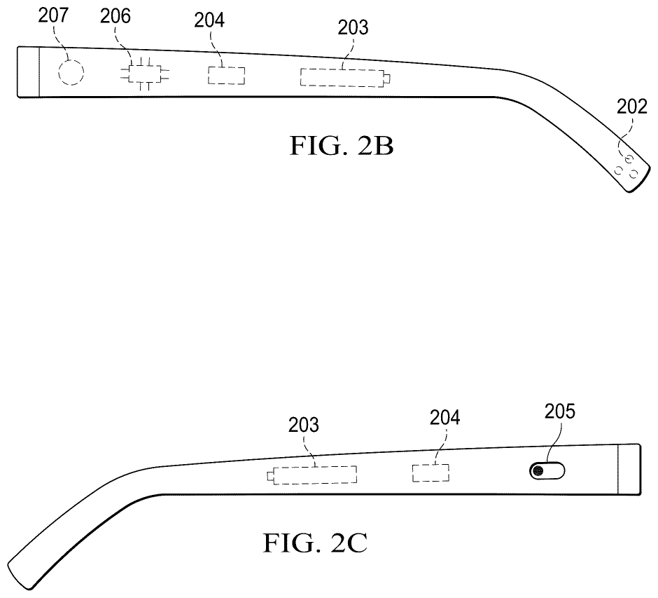

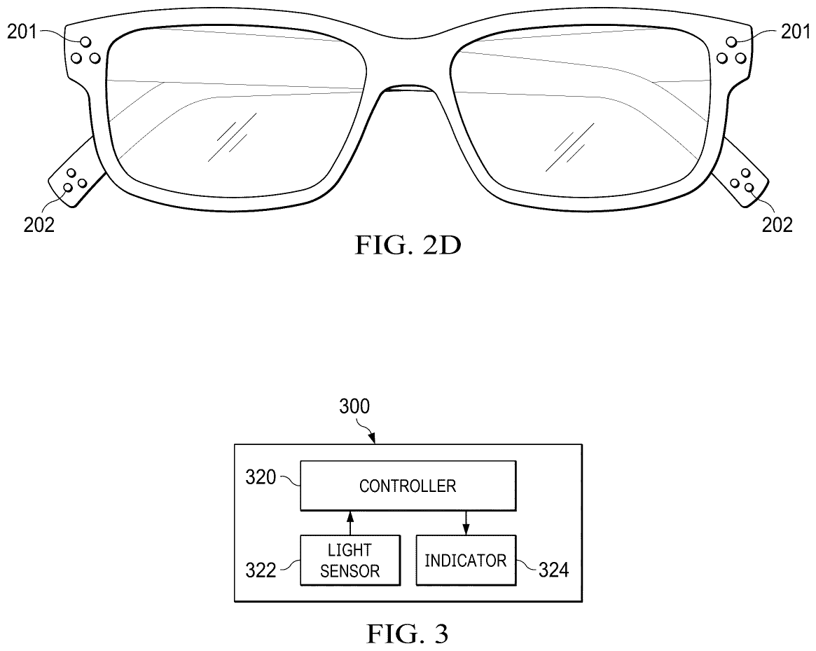

FIG. 2A shows a perspective view of a pair of eyeglasses 200 having frames and lenses. FIG. 2B shows a side view of the left temple piece of the eyeglasses 200 shown in FIG. 2A. FIG. 2C shows a side view of the right temple piece of the eyeglasses 200 shown in FIG. 2A. FIG. 2D shows a perspective view of the eyeglasses 200 shown in FIG. 2A, wherein the temple pieces are folded against the frames. A light sensor 201 is positioned in the frame near a lens. Charging pins 202 are positioned at the distal end of the left temple piece. A battery 203 is positioned in a temple piece. A haptic motor 204 is positioned in the lens frame. An ON/OFF switch 205 is positioned in the right temple piece. A microprocessor 206 is positioned in the left temple piece. A proximity sensor 207 is positioned in the left temple piece.

FIG. 3 shows a block diagram of a light monitoring and indicating system 300. The system 300 has a controller 320 that receives input data from a light sensor 322. The controller 320 also provides a control signal to an indicator 324 that provides an indication to a user that a preselected light condition has been sensed by the light sensor.

According to an aspect, the light monitoring and indicating system may be in the form of a light processing device comprising a housing and electrical components, wherein the electrical components comprise a light sensor, a controller, and an indicator, and wherein the housing may take any form that allows the device to be worn by a user about the head or neck to monitor the same or similar light as being observed by the user's eyes. The light processing device may clip on a pair of glasses being worn by a user. The light processing device may be a hair clip or tie that a user may wear int the hair. The device may be a pendant or a necklace the user may wear around the neck. The light processing device may be an earpiece the user may wear on the ear. The light processing device may attach to a hat or other headgear to be worn by the user. The light processing device may clip to the collar of the user's shirt or other article of clothing, wherein the light processing device may be positioned near the user's head to monitor the same or similar light as being observed by the user's eyes.

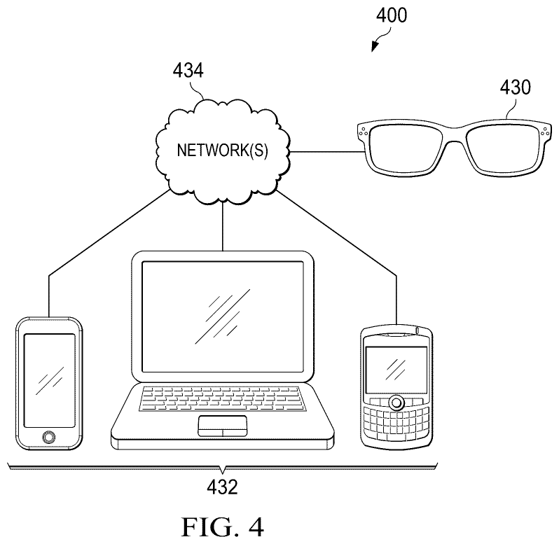

FIG. 4 shows a block diagram of a light processing system 400, which in this case has a light processing device (not shown) incorporated in the frames of a pair of eyeglasses 430, wherein the light processing device communicates with a computer 432 over a network 434.

An aspect provides a system where the light monitoring and indicating system is programmable to set light characteristic thresholds or other light parameters to be indicated to the user when observed by the system. The light processing device, which in this case is incorporated in the frames of a pair of eyeglasses, communicates via a network with a computer, such as a personal computer or a handheld mobile computer. The user may use a personal computer to set up or configure the light processing device. For example, the user may set thresholds for light characteristic, such as light type, light duration, light intensity, without limitation. The user may also set up the indications to be provided to the use when light characteristic thresholds have been observed, such as a vibration, an audible alarm, a visual light alarm, or an alarm signal transmitted to a user's computer. The user's computer may have a display and a touch screen, wherein a keyboard is simulated in the touch screen. In some instances, a smart phone (e.g., iPhone, Android-based phone, without limitation) having a wireless connection, ease-of-use keyboards or character inputs, and a processor may be configured as set-up controller by downloading and executing on the smart phone additional software. By using existing, popular smart phones, the consumer may avoid large incremental costs for a new, additional remote controller. Furthermore, by using industry-standard protocols that may be integrated with the downloaded software code, the smart phone configured as a remote controller may interact with diverse types of media sources, access content, and establish transfer of content among these media sources using a wireless adapter via a radio link, such as Bluetooth. The industry-standard protocols include DLNA, UPnP, protocols from Microsoft for Windows-based device control, and protocols from Apple for controlling iPod, iPhone, iPad, and/or iTunes-accessing devices.

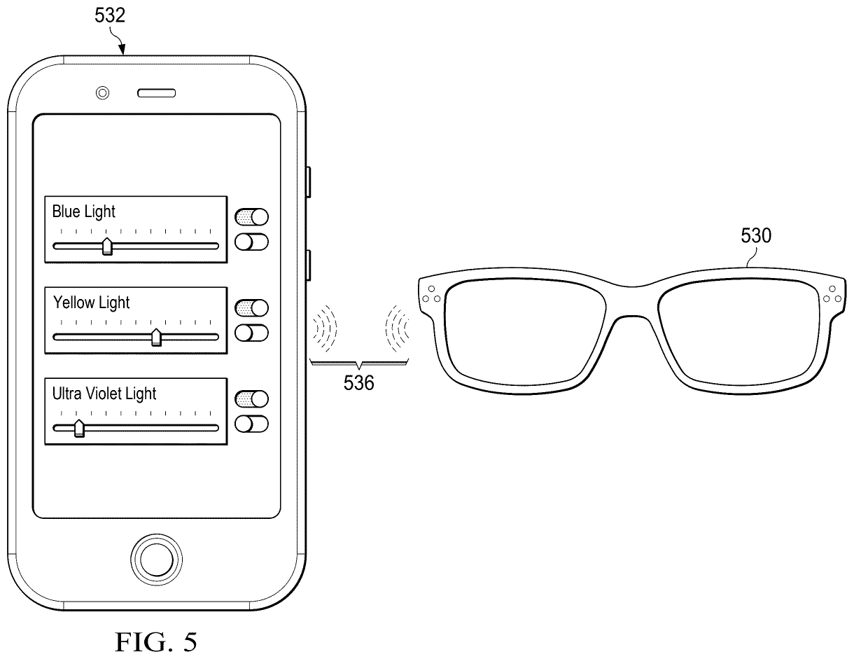

FIG. 5 shows a pair of eyeglasses 530 having a light processing device (not shown), communicating via a radio communication link 536 (for example, Bluethooth) with a handheld mobile computer 532. The user may program the light processing device via the handheld mobile computer to set thresholds for different types of light, for example, blue light, yellow light, and ultra violate light. For a type of light, a light characteristic may be selected and a threshold set, such as light duration, and light intensity, without limitation.

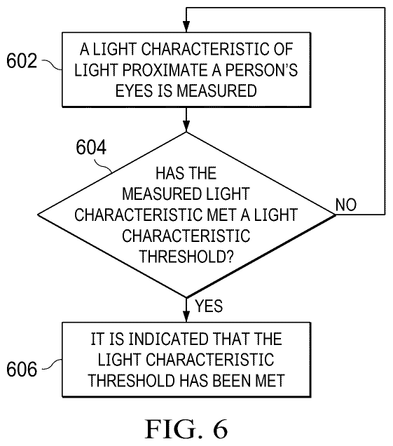

FIG. 6 shows a flow chart of a method. A light characteristic of light proximate a person's eyes is measure 602. A measured light characteristic that has met a light characteristic threshold is determined 604. If yes, it is indicated 606 that the light characteristic threshold has been met. If no, a light characteristic of light proximate a person's eyes is again measured 602.

Although examples have been described above, other variations and examples may be made from this disclosure without departing from the spirit and scope of these disclosed examples.

1. A method comprising:
measuring a light characteristic of light proximate a person's eyes;
determining that a measured light characteristic has met a light characteristic threshold, and indicating the light characteristic threshold has been met.

2. The method as in claim 1, comprising:
setting the light characteristic threshold.

3. The method as in claim 1, comprising:
configuring a light sensor to be positionable proximate the person's eyes.

4. The method as in claim 1, wherein the light characteristic is light type, light duration, or light intensity.

5. The method as in claim 4, wherein the light type is blue light, yellow light, or ultraviolet light.

6. The method as in claim 1, wherein indicating a light characteristic threshold has been met is sounding an audio speaker, displaying a visual light, vibrating a vibrator, sounding an alarm, displaying a visual display, storing a status flag in a memory register, or displaying a display on a computer.

7. The method as in claim 1, comprising changing light being viewed by the person's eyes in response to the light characteristic threshold having been met.

8. A device comprising:
a sensor to sense a light characteristic of light proximate to a person's eyes and to transmit a sensor signal, wherein the sensor signal corresponds to the light characteristic sensed by the sensor;
a controller to receive the sensor signal from the sensor, to determine that the light characteristic has met a light characteristic threshold, and to generate an indicator signal, wherein the indicator signal indicates the light characteristic threshold has been met; and
an indicator to receive the indicator signal from the controller and to generate an indication to a user.

9. The device as in claim 8, wherein the controller is to set the light characteristic threshold.

10. The device as in claim 8, comprising a housing to be positioned proximate the person's eyes.

11. The device as in claim 8, wherein the light characteristic is light type, light duration, or light intensity.

12. The device as in claim 11, wherein the light type is blue light, yellow light, or ultraviolet light.

13. The device as in claim 8, wherein the indicator is an audio speaker, a visual light, a vibrator, an alarm, a visual display, a status flag stored in a memory register, or a display on a computer.

14. A system comprising:
a device comprising:
a sensor to sense a light characteristic of light proximate to a person's eyes and to generate a sensor signal, wherein the sensor signal corresponds to the light characteristic sensed by the sensor; and
a radio transmitter to transmit the sensor signal;
a personal computing device comprising:
a radio receiver to receive the sensor signal;
a processor to receive the sensor signal from the radio receiver; and
a memory comprising an application with instructions stored in the memory, which when the application is executed by the processor causes the processor to:
determine that the light characteristic has met a light characteristic threshold, and
generate an indicator signal, wherein the indicator signal indicates the light characteristic threshold has been met; and
an indicator to receive the indicator signal from the processor and to generate an indication to the person.

15. The system as in claim 14, wherein the application comprises instructions stored in the memory, which when the application is executed by the processor causes the processor to set the light characteristic threshold.

16. The system as in claim 14, wherein the device comprises a housing to be positioned proximate the person's eyes.

17. The system as in claim 14, wherein the light characteristic is light type, light duration, or light intensity.

18. The system as in claim 17, wherein the light type is blue light, yellow light, or ultraviolet light.

19. The system as in claim 14, wherein the indicator is an audio speaker, a visual light, a vibrator, an alarm, a visual display, a status flag stored in a memory register, or a display on a computer.

20. The system as in claim 14, wherein the device comprises a lens and the application comprises instructions stored in the memory, which when the application is executed by the processor causes the lens to change light being viewed by the person's eyes in response to the light characteristic threshold having been met.
